(19) United States
(12) Patent Application Publication
(10) Pub. No.: US 2014/0282925 A1
(43) Pub. Date: Sep. 18, 2014

(54) Personal Authentication Device and System for Securing Transactions on a Mobile Device

(71) Applicant: Sypris Electronics, LLC, Tampa, FL (US)

(72) Inventors: John J. Walsh, Lutz, FL (US); Hal A. Aldridge, Tampa, FL (US)

(73) Assignee: Sypris Electronics, LLC, Tampa, FL (US)

(21) Appl. No.: 13/832,885

(22) Filed: Mar. 15, 2013

(51) Int. Cl. H04L 29/06

(52) U.S. Cl. CPC H04L 63/08
USPC 726/5

(57) ABSTRACT

A personal authentication device for use with a mobile device, comprising a secure processor, a crypto engine supporting certificate functions, a wireless communication module, a cryptographic engine, a memory, a hardware based identity, a policy engine, one or more security features; and an on-board main power battery. Also a system comprising the personal authentication device and a verification authority, and an associated method of authentication.

### BACKGROUND

Mobile devices are becoming a hub for many types of personal and business transactions. Some of these transactions can authorize, disclose, or perform operations on sensitive data. While mobile device security is improving, it still may not be adequate for a given transaction; for example it is not practical to enable a high assurance security certification in a full mobile device. In such cases, security could be improved if there were a further means to reliably identify that the mobile device's current operator is an authorized user in connection with a prospective transaction. Tying personal identities to mobile devices, however, may not be a desirable means of doing so since many mobile devices are not fully owned and controlled by one individual.

### BRIEF DESCRIPTION OF THE DRAWING

FIG. 1 depicts a Personal Authenticator transaction authentication process.

### DETAILED DESCRIPTION OF EMBODIMENTS

The Personal Authenticator (“PA”) is an electronic device that provides authorization and identity functions that are more secure than those that can be cost effectively incorporated into a volume mobile device. The PA functions together with a Verification Authority (“VA”) as a system, employing a combination of traditional (certificate-based) and new (hardware-based) identity methods so as to enable highly secure authorization of transactions on common mobile devices. The system is used on an ad hoc basis to authenticate transactions, with bulk encryption, etc. handled by the mobile device. The level of trust in the transactions depends on the PA and the VA, and not the intermediate mobile device.

A PA preferably includes a secure processor to provide coordination of functions, policy management, etc., a hardware identity device/circuit, a crypto engine supporting certificate functions and other crypto elements to provide secure communication to the mobile device, a secure boot module, and a non-volatile secure memory for storing account information, certificates, hardware identity associations with accounts, account policies, and user data. The PA preferably includes security features to enable a high assurance security certification (such as FIPS 140-2 level 3), and may incorporate anti-tamper features. The PA can be embodied in a small, battery-powered device that can be integrated into various form factors such as traditional card and fob token devices and newer devices such as eyewear based computing, and may be physically connected (e.g., embodied in a microSD card) or wirelessly-paired to the mobile device. The PA may for example be built around a small, low-powered FPGA that is compatible with a hardware based identity feature (such as a Physically Unclonable Function (PUF)) and can support the PA's requirements including the basic authentication functionality of handling certificates and hardware identity data (including the PUF), and can incorporate a commercially available wireless chip supporting Bluetooth or NFC transmission. The PA may include a method to authenticate the user the PA using techniques such as a biometric sensor or a PIN/password. The PA may also include a method for the user to specifically monitor and authorize a transaction independent of the automated functions such as a display and button(s).

The PA concept for transaction processing incorporates some traditional token functions such as secure certificate storage with some additional features needed to support secure transactions in an untrusted environment. These features include the addition of hardware based identity to provide secure identity for the transactions, an enrollment schema that includes hardware based identity data and secure setup independent of communication channel, and a policy enforcement engine to regulate the approval of transactions independent of the untrusted environment.

The PA preferably can work with multiple VAs operated by different organizations (banks, enterprises, etc.), enforce transaction policies (e.g., no payments over $500, no payments between 2a-6 am, health-related data only to hospital, etc.), and provide secure data at rest for key personal information. The present system (including the PAs and the VAs) preferably does not require hardware modification to most modern mobile devices. Preferably it may be compatible with existing authentication methods (preferably requiring no or minimal modifications of back-end systems), and with existing infrastructure and software-only security implementations.

The PA supports traditional identity techniques such as certificates for compatibility with existing infrastructure. The inclusion of hardware identity features such as PUF enables a higher level of identity assurance. The traditional certificate data can be mixed with the hardware based ID features in a method similar to that set forth in Kirkpatrick et al., PUF ROKs: A Hardware Approach to Read-Once Keys, ASIACCS '11, Proceedings of the 6th ACM Symposium on Information, Computer and Communications Security, Mar. 22-24, 2011 (ACM), where the two concepts merge to become an identity which incorporates both the device identity and authorizations implied the certificates. This combination of identity data results in a higher level of assurance in the PA authentication.

The PA transaction authentication process is shown in FIG. 1. Step 1 is Request. A device such as a SMD connected or paired with the PA transmits transaction to the PA and requests it be authenticated. Step 2 is Authentication. The PA uses RDAS and Certificate data stored in the PA during enrollment to decrypt the transaction and confirm source of the transaction. Step 3 is Policy Enforcement. The PA checks internal policies within its internal policy engine to see if transaction meets user and AP criteria (e.g., no financial transaction over $500). This criterion can also include the trust level of the device that sent the request. Step 4 is Validation. If the PA determines that the identity of the sending device is authenticated and the policy requirements are met it will approve the transaction. This can include an optional step for the user to give final confirmation. Step 5 is Signature. The validated transaction will be cryptographically signed by the PA using hardware identity data and certificate data. The resulting signed transaction will be encrypted by the PA and sent back to the requesting device.

In addition to the PA and the VA, the system includes an Account Provider (AP) such as a bank, Health Management Account (HMA), email account, cloud storage account, etc. In one model, the user purchases a PA from a company that provides both the PA and a VA service; the company identifies and stores hardware identity data in the PA and stores it at the VA. In use cases, a user creates an account with an AP, which then communicates with the PA's associated VA and obtains hardware identity information pertaining to the PA with which to augment its own security information. In this case, there is independence between the AP's systems and the VA, and the VA preferably only provides a subset of the hardware identity information to the AP to both maintain security of the PA and to allow other APs to access the PA. The AP preferably controls its own certificates and communication with the PA independently from the VA.

Such a system can be used to provide an account setup wherein hardware identity information uniquely identifies a PA with high assurance so that only the intended PA can decrypt sensitive data in the process. In an example of this case, a user selects a Bank that supports the user's PA, and gives the bank information to request an account including information that identifies the user's PA (serial number, VA provider, or other info that ties the user to the PA). The Bank then requests PA authorization data from the VA, which data will uniquely identify the PA to the bank using hardware identity information unique to the PA. The VA preferably contains enough PA hardware identity data for any given PA to support numerous accounts, and utilizes only a subset of that data in its provision of authorization data to the Bank. The Bank uses the hardware identity data to securely encrypt provisioning information (certificate, policies, etc) to send to the PA. (A system including authentication of subsidiary entities by Verification Authority including the use of hardware identity information such as in the form of a PUF is disclosed in detail in Assignee's pending application Ser. No. 13/552,592 entitled “Resilient Device Authentication System” and filed on Jul. 18, 2012, the teachings of which in that regard are incorporated herein by reference). The user then installs the Bank's app on the user's mobile device, and the PA is paired/connected to the mobile device. The app then connects to the bank and the PA, and transfers the encrypted provisioning information from the Bank to the PA. Neither the app nor the mobile device can decrypt the information, but rather only provide connectivity between the Bank and PA. The PA recognizes the information provided by the VA and, using hardware identity information, verifies that the Bank is authorized to provision its information on the PA. The PA assigns secure storage and policy enforcement information as needed by the Bank, using a combination of Bank-provided certificate and the hardware identity data to sign a response confirming receipt and setup. The PA uses the Bank's app on the paired mobile device to send the confirmation to the Bank, and the Bank validates the confirmation and the account setup is complete.

Such a system also can be used to similarly secure financial transactions. In an example of this case, a user will have previously opened a PA-enabled account with a Bank, installed the Bank's app on their mobile device, and provisioned the user's PA with the Bank's account information. At some point the user desires to authorize the Bank to perform a transaction, for example a bill payment. To do so, the user opens the Bank's app, which confirms that the PA is connected/paired to the mobile device and then connects to the Bank. The Bank sends a signed message incorporating hardware identity data to the app to confirm the user's PA is connected, and the app sends the signed message to the PA. The PA verifies that it is the Bank and the account on the PA, and uses the Bank-provided certificate stored in its memory and PA specific-hardware identity data to sign a message to confirm it is online, which message is then sent to the Bank via the app. The Bank then validates the message and logs on the user to the app. In one embodiment (that assumes some trust in the mobile device), the Bank's app then functions conventionally, allows the user to access account information, identify the bill to be paid, and request that the bill be paid. In this embodiment, when the user requests the Bill to be paid, it formats the requesting message and sends the message to the connected/paired PA, which inspects the message to identify that it is a Bill pay request to an authorized account meeting any internal policies. If the PA verifies that the Bill request meets policy guidelines, it signs the request using the Bank-provided Certificate and hardware identity data. Depending on the PA type and policy, the user may then interact directly with the PA as a final authorization step to send the signed Bill pay authorization to the app. In any case, upon authorization, the app sends the PA-signed authorization to the Bank, which validates the request and causes the bill to be paid.

In one embodiment, the system can provide for optional backward compatibility with existing authentication methods. In this case, the system could be configured to enable the user and Bank to agree (during the user's initial account setup, or a subsequent modification) that some transactions can be performed without the PA. The Bank then provisions the user's mobile device with an alternate certificate (not based on a hardware identity) that can be used to sign transactions of types allowed by policy at this level of security. The mobile device and app use available security features to securely store and process the certificate as needed to support transactions, and when the Bank receives a transaction request signed with this alternate certificate, it authenticates the request and checks policy to ensure that the alternate certificate is allowed for the particular transaction before executing it.

In another embodiment, the system can be designed so that the AP does not require the PA to authenticate a transaction, but just that the PA be present during the transaction. In this case, taking again the example of a Bank as the AP, the user would open the banking app on the mobile device, the app would confirm that a PA is connected/paired to the mobile device, and the app would connect the PA to the Bank. At that point, login could proceed as described above; depending on the type of PA and policy the login can be automatic or require a confirmation by the user on the PA, and/or the PA and Bank authentication cycle may recur periodically to maintain an open session.

In another embodiment, the system can employ the PA without a mobile device. For example, in a case where the AP is a Health Management Account (HMA) that allows users to own and control their own health records, a user would enroll in a PA-enabled HMA as described above in the banking example. When at a health provider's office that is authorized to handle HMA data, the user would connect/pair the PA to a terminal at the office. The PA would authenticate with the HMA as done with a financial transaction as described above. In the HMA transaction, the user could authorize the health care provider to access specified portions of the user's health information, enable the provider to update information, and may employ policies such as limiting the time during which the health information will be accessible by the provider. If the health information is stored in the HMA cloud, access would be granted for the provider to information in the cloud, or if securely stored in the PA, the information could be transferred from the PA to the provider's system. The system may be configured so that in an emergency the PA could be provisioned by the HMA with certificates used by properly-provisioned EMS mobile devices that can pair or connect with the PA, authorizing the PA to provide essential health information (blood type, allergies, etc.) to the EMS mobile device for emergency care.

The PA is designed to provide a method to securely authenticate transactions when the device requesting transaction has a lower level of trust than the AP or the PA. The tunnels for communications between the AP and PA can be encrypted such the requesting device cannot read the communications. The policy engine in the PA inspects the transaction to ensure it is within policy requirements previously securely enrolled by the AP and user. This combination of features can prevent or mitigate the effect of an rogue request. For example, the AP's application on the requesting device has been replace maliciously by an malware that requests user information to approve a transaction to transfer funds an account not authorized by the user or AP. The AP will not process the request unless it is validated by the AP. The policy engine running on the AP independently from malware on the requesting device detects that the request violates policy and does not approve the transaction. Depending on policy, the PA may respond to the AP with an invalid request notification and the AP may take appropriate actions to secure the user's account against other fraud.

Optionally, end-to-end security can be enhanced with a Secure Mobile Device (SMD) that can securely store certificates for access only by authorized applications executed in a securely separated partition where the SMD provides secure data tunnels to the AP and PA. Taking for example the case of a user with an existing bank account that has been provisioned to their PA, the user would purchase a SMD for use with the PA and download the bank's app to the SMD, which executes the app in its secure partition. Through established standards or other means agreed to by the bank and SMD manufacturer (which could include hardware identity information) the bank would recognize when it is communicating with a SMD, upon which a secure connection using certificates, etc. would be established between the two. The app would then connect/pair with the PA, and similarly to the bank/SMD secure communication establishment, the SMD and PA would use suitable methods to establish a secure connection/pairing. If the app provides the bank's info and requests an acknowledgement message from the PA, the PA signs a message using the previously provisioned bank certificate and sends it to the bank via the SMD. The bank would then recognize the PA, and associate the SMD and PA pair as an authorized combination of secure elements that can access the account (though the system may be configured to permit the PA to establish connections with other SMDs). Depending on applicable policy, the bank will transmit certificates/policy for the SMD and app to use to access the bank account without the PA.

One skilled in the art will appreciate that other variations, modifications, and applications are also within the scope of the present invention. For example, while the device is discussed as a Personal Authenticator, a similar embodiment could be provided in cyber-physical devices such as a smart meter, flight actuator (which like a full mobile device typically are not practically amenable to enabling a high assurance security certification), etc. that needs to provide high-assurance authentication. A similar embodiment could support machine to machine authentication between computer network devices enabling high assurance authentication of data sources and metadata. Thus, the foregoing detailed description is not intended to limit the invention in any way, which is limited only by the following claims and their legal equivalents.

What is claimed is:

1. A personal authentication device for use with a mobile device, comprising:
a. a secure processor;
b. a crypto engine supporting certificate functions;
c. a wireless communication module;
d. a secure non-volatile memory;
e. a hardware fingerprint means that comprises a fingerprint device or a fingerprint circuit;
f. one or more security features; and
g. an on-board main power battery.

2. The device of claim 1, wherein the hardware fingerprint device or fingerprint circuit is a PUF.

3. The device of claim 1, wherein the one or more security features is of a class enabling the device to be associated with a FIPS 140-2 level 3 certification.

4. The device of claim 1, wherein the wireless communication module is Bluetooth or NFC.

5. The device of claim 1, wherein the wireless communication module is Bluetooth or NFC and the one or more security features is of a class enabling the device to be associated with a FIPS 140-2 level 3 certification.

6. The device of claim 1, wherein the wireless communication module is Bluetooth or NFC, and the one or more security features is of a class enabling the device to be associated with a FIPS 140-2 level 3 certification, and the hardware fingerprint device or fingerprint circuit is a PUF.

7. The device of claim 1, wherein the hardware fingerprint device or fingerprint circuit is a PUF and the one or more security features is of a class enabling the device to be associated with a FIPS 140-2 level 3 certification.

8. The device of claim 1, wherein the hardware fingerprint device or fingerprint circuit is a PUF and the wireless communication module is Bluetooth or NFC.

9. A system comprising one or more of the devices of claim 1, and one or more secure mobile devices that store certificates accessible for execution only by authorized applications in a securely separated partition that includes means for establishing secure data tunnels to an authorized account provider and to at least one of the devices of claim 1.

10. The device of claim 1, wherein the device is configured to directly or indirectly communicate information with the provider of an account that is associated with the device through binding to the identity of a specific human individual.

11. The device of claim 1, wherein the device is associated with a mobile device.

12. The device of claim 11, wherein the wireless communication module is configured to communicate with the mobile device.

13. The device of claim 11, wherein the wireless communication module is configured to directly or indirectly communicate with a mobile device, a verification authority, and an account provider.

14. The device of claim 1, wherein the memory stores one or more authentication certificates.

15. The device of claim 1, wherein the memory stores one or more authentication certificates and the hardware fingerprint device or fingerprint circuit is a PUF.

16. The device of claim 1, further comprising a secure boot module.

17. A system comprising one or more of the devices of claim 1, wherein the wireless communication module is configured to directly or indirectly communicate with a mobile device, a verification authority, and an account provider.

18. The system of claim 17, wherein the account provider is a bank.

19. The system of claim 17, wherein the account provider possesses health records.

20. The system of claim 17, wherein one or more individual humans are associated with the account provider through an account corresponding to the individual.

21. The device of claim 1, wherein the memory contains policy data obtained through interactions between the device and an account provider.

22. The device of claim 21, wherein the memory contains policy data associated with a secure enrollment of a user with an account provider.

23. The device of claim 1, wherein the secure processor includes a policy engine that is adapted to determine whether a transaction complies with policy data.

24. The device of claim 23, wherein the policy engine is further adapted to authorize transactions that comply with policy data.

25. The device of claim 15, wherein the certificate is a certificate traditionally used for identity processing.

26. The device of claim 15, wherein the device is adapted to utilize both the authentication certificates and the PUF in a manner that increases transactional security beyond what either means can provide alone.
